(19) United States
(12) Patent Application Publication
(10) Pub. No.: US 2008/0035104 A1
(43) Pub. Date: Feb. 14, 2008

(54) Redesigned engine cam for rotary engine

(76) Inventor: James McCann, San Leandro, CA (US)

Correspondence Address: James McCann;c/o Jim Deleon, 13818 Tortuga Rd., San Leandro, CA, 94577-5429, US

(21) Appl. No.: 11/494,386

(22) Filed: Jul. 27, 2006

(51) Int. Cl. F02B 53/04

(52) U.S. Cl. 123/231; 123/223; 123/236

(57) ABSTRACT

An improved rotary engine that involves sealing the engine with double spigot seals and redesigning the cam so that the engine duplicates every 10 degrees rather than the 18 degrees of the most relevant prior art. The first part of the cam separates the intake from the exhaust and has a close tolerance fit that prevents the exhaust from containing the air/fuel mixture. In the compression/power area of the cam, a gap is created that allows the transfer of the air/fuel mixture to be moved into firing position.

### FIELD OF THE INVENTION

The present invention generally relates to rotary engines.

### BACKGROUND OF THE INVENTION

In an ordinary piston engine, the intake valve opens about 20 degrees before top dead center and the exhaust valve closes about 20 degrees after top dead center. This means that the two valves are open for about 40 degrees at the same time. The exhausting gases then are polluting the intake gases and the unburned gases of the intake stroke are being exhausted without burning. This system is very inefficient. Existing rotary engines have these same valve overlap problems as a standard piston fired engine.

Rotary engine prior art, such as the Rand-Cam® engine, typically involves a rotary system and a large number of vanes, usually twelve, as in the Rand-Cam® example. In an ordinary engine, e.g. an engine with pistons and crankshaft, there are four strokes that are made every 720 degrees (two revolutions). These strokes include: intake, compression power and exhaust. Where a standard engine uses 720 degrees to achieve the four stroke sequence, the instant invention uses 72 degrees thus creating an engine with six moving parts that produces ten firing strokes per revolution, which is equal to an ordinary engine of 20 cylinders.

Where an ordinary engine has a bore equal to the length of the stroke, the instant invention has a stroke four times the length of the diameter of the bore, which allows more time to burn the fuel. Where an ordinary engine, as well as traditionally rotary engines, has valve overlap (where both the intake and exhaust valves are open at the same time), the instant invention has no such overlap. There exists a need for a rotary engine that overcomes the shortcomings of the prior art, and that need is met by the instant invention.

### SUMMARY OF THE INVENTION

In the preferred embodiment of the invention, an improved rotary engine is described wherein the cam profile between the exhaust and intake strokes is touching and the cam between the compression and power strokes has a gap. This configuration gives the engine a better performance because there are no abnormal events, such as valve overlap, between the exhaust and intake, thereby giving the engine an unpolluted gas mixture. On the other end, the gap between the compression and power strokes allows the mixture to come into position for firing.

The improved engine uses five vanes rather than the twelve find in the Rand-Cam® prior art. With a five vane engine, the compression ratio is increased. Zirconium bromide is used to stop metal pick up by the vanes. Zirconium bromide is used to coat the vanes as well as the vane seals. The instant invention has an increased stroke thereby increasing the time needed to burn the fuel, which in turn increase the fuel economy to a significant degree. Because there are no abnormal events, the stroke is greater than the bore and very little fuel is burned and what fuel that is burned is burned in the engine and not in the muffler. The instant engine has very few pollutants and very little noise. The function of the vane seals is to give the seal enough flexibility to seal and be able to maintain the correct distance without binding. The use of zirconium bromide stops the build up of heat and reduces friction.

The improved engine is sealed through the utilization of double spigot seals. The seals are enclosed in both the rotor and the stator housing. The seals are also made of a zirconium bromide coating that prevents sticking and friction. The seals make a high compression ratio possible, which in turn makes the engine able to burn as either a gasoline or diesel engine.

Visualizing a piston in a car and the piston rings, one can begin to understand the current invention. The piston ring fits into a groove in the piston and rides against the wall of the cylinder. The only way the compression is kept is due to the speed of the piston, reducing the time for the leakage that occurs between the piston ring and the wall of the cylinder. By using the double spigot seal, the current invention is able to reduce gas losses that result in low speed engines giving better compression and also the ability to run the engine at slow speed. A spigot is a ring that is machined as part of one side of part of plates. A problem may occur if there is a build up of heat when the spigot can seize. However, the double spigot seal is designed so that if one side seizes then there is still the other to continue the sealing of the compressed gases. The double spigot seal is a combination of a ring similar to the piston ring that weds into two grooves in both halves of the plate system.

### OBJECT OF THE INVENTION

The principal object of the invention is to provide a higher efficiency rotary engine.

Numerous other advantages and features of and various means for practicing the invention will become apparent from the detailed description of the preferred embodiment of the invention, from the claims, and from the accompanying drawings, in which like numerals are used to designate like parts shown in different figures.

### BRIEF DESCRIPTION OF THE DRAWINGS

FIG. 1 illustrates a cross-sectional view of the engine.

FIG. 2 illustrates an exploded cross-sectional view of the engine.

### DETAILED DESCRIPTION OF AN ENABLING AND PREFERRED EMBODIMENT

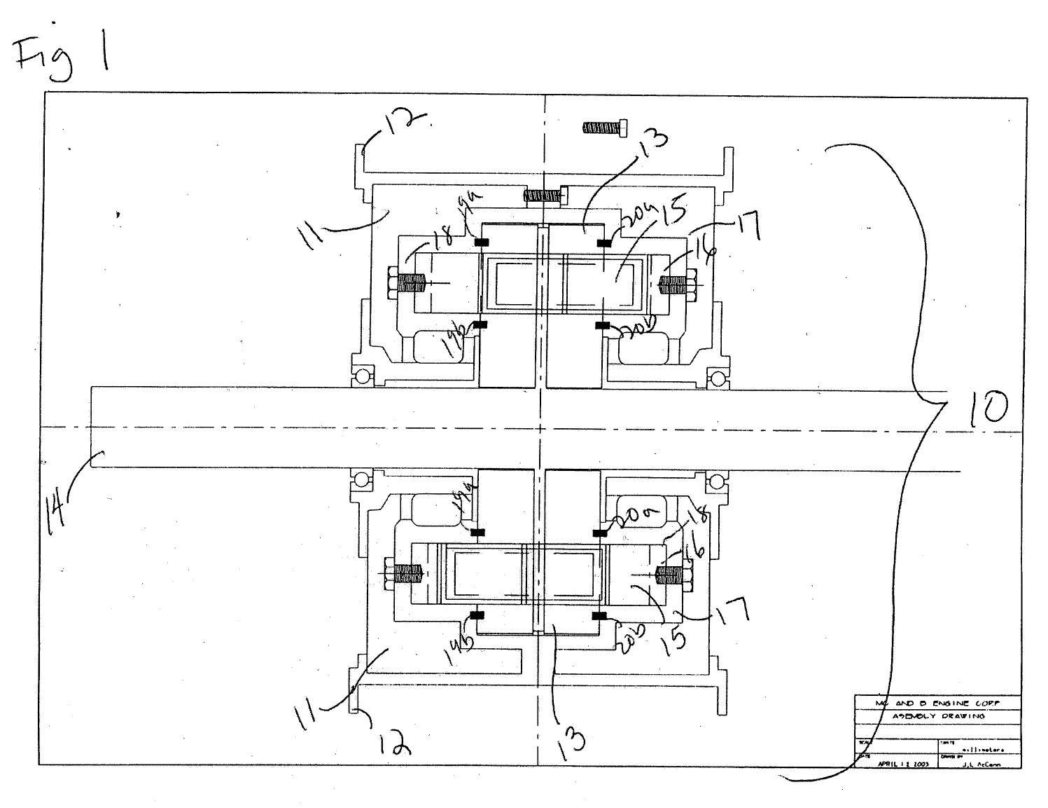

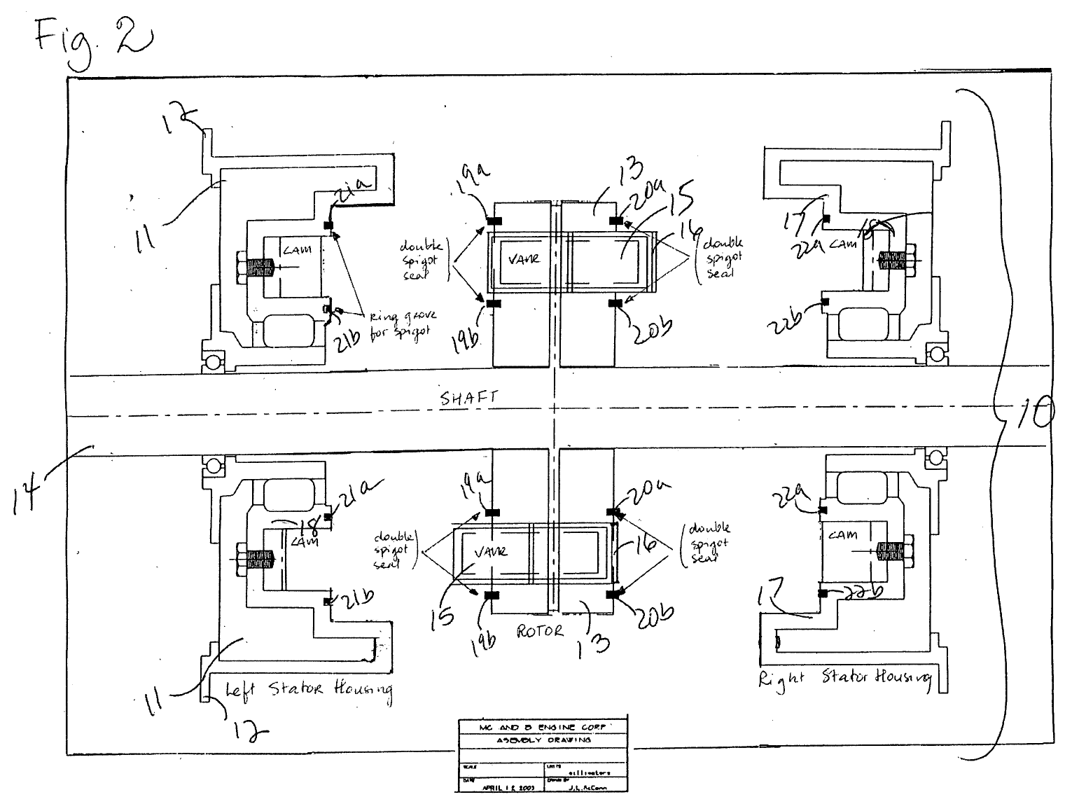

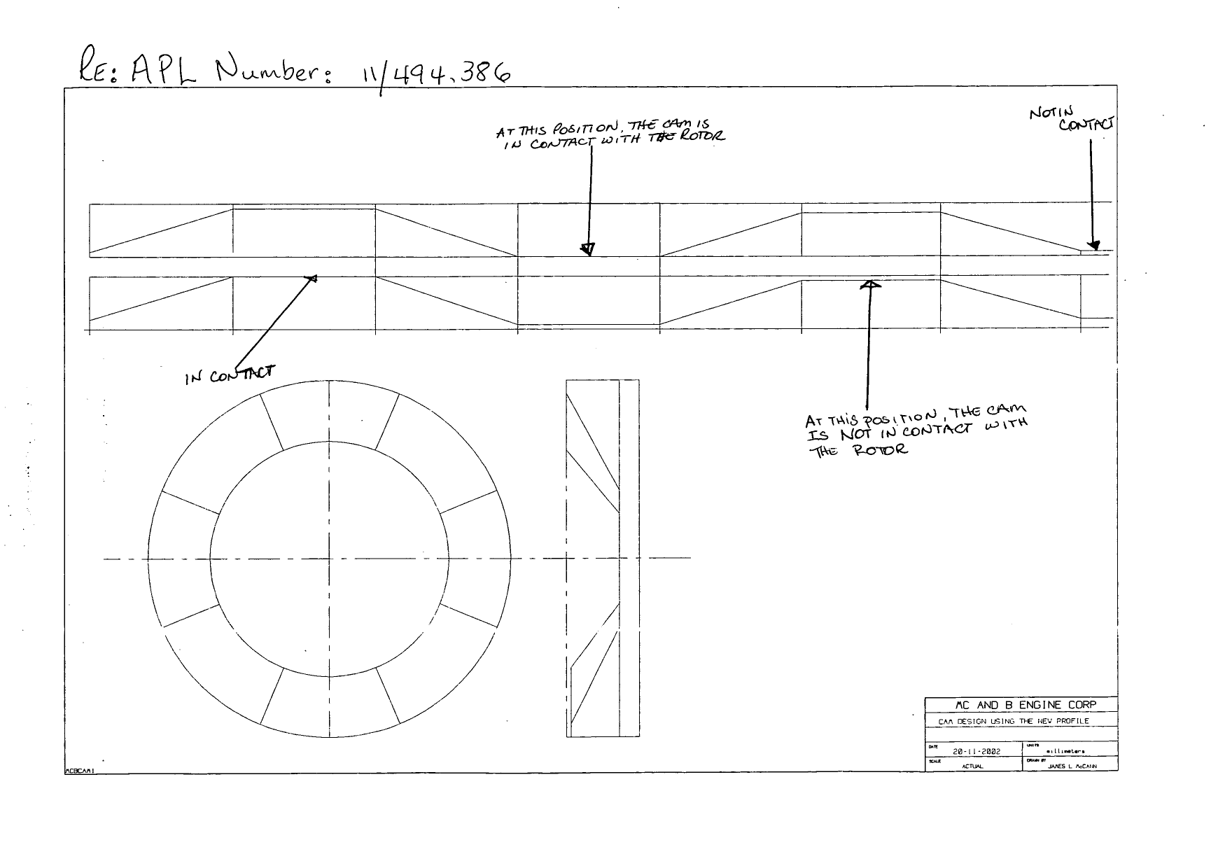

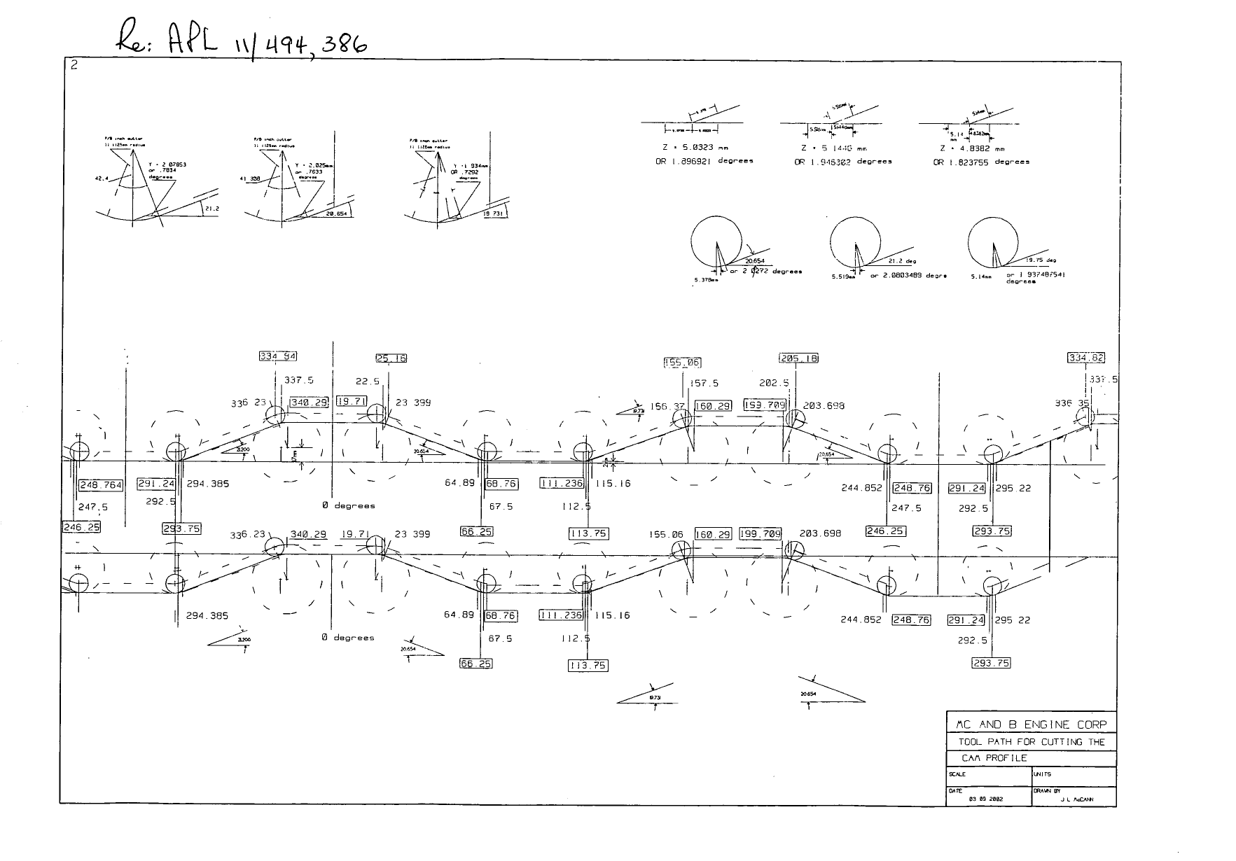

For a better understanding of the invention, we turn now to the drawings. In FIG. 1 the invention is shown in cross-sectional view. In FIG. 2 the invention is shown in an exploded cross-sectional view. The invention is an improved efficiency rotary engine 10 utilizing the standard four strokes found in the art, namely intake, compression, power and exhaust. The engine 10 contains a hollow stator 11 with an external housing 12, a rotor 13 having a shaft 14 rotatably supported inside of the stator 11. Included are a plurality of radially extending vanes 15 slidably received in slots (not shown) located on the rotor 13 and having an outer end 16 contacting the peripheral wall 17 of the stator 11, with the vanes being sealed.

The engine has a cam 18 projecting from the rotor shaft 14 that strikes the vanes 15 during operation. The cam 18 thereby isolates the intake stroke and exhaust strokes from each other thereby preventing the pollution of the intake gases by the exhaust gases. Further, the intake gases are not expelled along with the exhaust gases. Enclosed in the rotor 13 and the stator housing 12 are double spigot seals 19a, 19b, 20a, 20b to prevent gases from completely escaping the engine 10. The double spigot seals 19a, 19b, 20a, 20b are a combination of rings located on the rotor 13 and that wed into corresponding grooves 21a, 21b, 22a, 22b located in the stator housing 12.

In the preferred embodiment of the invention, the number of vanes 15 does not exceed five. The vanes 15, the vane seals (not shown) and the spigot seals 19a, 19b, 20a, 20b are all coated with zirconium bromide to prevent metal pick up and heat build up due to friction.

The illustrations and examples provided herein are for explanatory purposes and are not intended to limit the scope of the appended claims, as those skilled in the art will make modifications to the invention for particular uses.

I claim:

1. An improved efficiency rotary engine utilizing the standard four strokes found in the art, namely intake, compression, power and exhaust, said rotary engine comprising
a hollow stator with an external housing;
a rotor having a shaft rotatably supported inside of said stator;
a plurality of radially extending vanes slidably received in slots located on said rotor and having an outer end contacting the peripheral wall of said stator, said vanes being sealed;
a cam projecting from said rotor shaft that strikes said vanes during operation, said cam isolating the intake stroke and exhaust strokes from each other thereby preventing the pollution of said intake gases by said exhaust gases and whereby said intake gases are not expelled along with said exhaust gases;
double spigot seals enclosed in said rotor and said stator housing to prevent gases from completely escaping said engine whereby said double spigot seals are a combination of rings located on said rotor and that wed into corresponding grooves located in said stator housing.

2. An improved efficiency rotary engine as described in claim 1 wherein the number of vanes utilized is five.

3. An improved efficiency rotary engine as described in claim 1 wherein said vanes are coated with zirconium bromide.

4. An improved efficiency rotary engine as described in claim 1 wherein vane seals are coated with zirconium bromide.

5. An improved efficiency rotary engine as described in claim 1 wherein said spigot seals are coated with zirconium bromide.
